(19) United States
(12) Patent Application Publication
(10) Pub. No.: US 2004/0154887 A1
(43) Pub. Date: Aug. 12, 2004

(54) Suspension control system and related damper with integrated local controller and sensors

(76) Inventors: Thomas W. Nehl, Shelby Township, MI (US); Fang Deng, Novi, MI (US); David J. Barta, Beavercreek, OH (US); Eric L. Jensen, Dayton, OH (US); Bruce A. Heaston, West Milton, OH (US); Alexander A. Alexandridis, Orchard Lake Village, MI (US); Malakondaiah Naidu, Troy, MI (US); Suresh Gopalakrishnan, Auburn Hills, MI (US)

Correspondence Address: DELPHI TECHNOLOGIES, INC., M/C 480-410-202, PO BOX 5052, TROY, MI, 48007, US

(21) Appl. No.: 10/723,066

(22) Filed: Nov. 26, 2003

Related U.S. Application Data
(60) Provisional application No. 60/429,592, filed on Nov. 27, 2002.

(51) Int. Cl. F16F 9/34; F16F 15/03

(52) U.S. Cl. 188/266.2; 188/267

(57) ABSTRACT

A suspension control system includes a plurality of damper assemblies, each damper assembly including an integrated velocity sensor and an integrated local controller with a drive unit connected to a damper coil of the damper assembly. A central controller may be connected for communication with the integrated local controller of each damper assembly. The local controller of each damper assembly normally controls the damper assembly independently of the central controller or other damper assemblies for carrying out at least one control function of the damper assembly. When provided, the central controller communicates with the local controller of each damper assembly for overriding local control functions. A related self-contained piston damper unit is also provided.

### CROSS-REFERENCE

This application claims the benefit of U.S. provisional application Serial No. 60/429,592, filed Nov. 27, 2002, the entirety of which is incorporated herein by reference.

### TECHNICAL FIELD

The present invention relates to suspension control systems and more specifically to a damper with an integrated controller and sensors, and to a hierarchical suspension control system implementable using such a damper.

### BACKGROUND OF THE INVENTION

Suspension control systems often include a centralized controller that includes a power drive unit to control the functions of the damper assemblies. The use of a single controller may adversely affect reliability and failure modes of the complete system. Furthermore, the use of such a centralized control system architecture precludes the possibility of system operational check prior to its complete assembly and interconnection within a vehicle.

Other suspension control systems include sensors that are independent of the damper and thus require further effort to assemble/integrate in the vehicle. The fact that the sensor is not integrated and thus collocated with the damper implies also the need for calibration of the sensor because it is not measuring exactly the motion of the damper.

It would be desirable, therefore, to provide a suspension control system that overcomes these and other disadvantages.

### SUMMARY OF THE INVENTION

In a first aspect, a hierarchical suspension control system in a wheeled vehicle includes a plurality of damper assemblies, each damper assembly operatively connected between a vehicle body and a corresponding vehicle wheel, and each damper assembly including an integrated velocity sensor and an integrated local controller with a drive unit connected to a damper coil of the damper assembly. A central controller is connected for communication with the integrated local controller of each damper assembly. During certain times the local controller of each damper assembly controls the damper assembly independently of the central controller. During other times the central controller communicates with the local controller of each damper assembly for overriding local suspension control functions.

In another aspect, a self-contained piston damper unit includes a damper body and a piston rod that is axially movable within the damper body and that is attachable to a vehicle body. A relative velocity sensor provides an output indicative of relative velocity as between the piston rod and damper body. A local controller is connected to receive an output of the relative velocity sensor and includes a drive unit connected for energizing a damper coil of the damper unit. The local controller may have a communications interface for connection to a central controller, but is also configured to independently carry out one or more suspension control functions of the damper unit. The damper body, piston rod, relative velocity sensor and local controller with damper coil drive unit are integrated into a single assembly mountable as a unit to a vehicle.

In a further aspect, in a suspension control system of a wheeled vehicle including multiple damper assemblies, each damper assembly associated with a respective wheel of the vehicle, a method for effecting suspension control functions using the damper assemblies involves the steps of: providing each damper assembly with an integrated local controller and associated damper coil drive unit; connecting the damper coil drive unit of each damper assembly to a power source; and configuring the local controller of each damper assembly to independently effect one or more local suspension control functions without reference to local suspension control functions being carried out by the other damper assemblies.

### SUMMARY OF THE DRAWINGS

FIG. 1 is a schematic view of an exemplary embodiment of a distributed or hierarchical suspension control system configuration;

FIGS. 2A and 2B illustrate a damper assembly with local controller that is included in the suspension control system of FIG. 1;

FIG. 3 illustrates one embodiment of a local control module of the damper illustrated in FIGS. 2A to 2B;

FIG. 4 is a schematic illustration of a power drive unit;

FIG. 5 is schematic illustration of a power drive unit with a local micro controller;

FIGS. 6A and 6B illustrate a prior art power drive unit of a central controller and typical coil current transients, respectively;

FIG. 7 is a diagrammatic representation of a prior art sensor incorporated within the dust tube of a damper;

FIG. 8 is a longitudinal cross-sectional view of a damper assembly and a dust tube subassembly thereof, wherein the sensor coils surround the prongs of the flux collector, and with the piston damper shown in jounce;

FIG. 9 is a perspective exterior view of the damper assembly of FIG. 8, with the dust tube omitted for clarity, with only a portion of the piston rod shown, with the damper shown in rebound, and with an alternate placement of the sensor coils, wherein the sensor coils surround segments of the ring of the flux collector; and

FIG. 10 is an end view of an alternate embodiment of a dust tube subassembly, with the top of the dust cover omitted, wherein the ring of the flux collector is smaller than that of FIGS. 8 and 9, wherein the flux collector includes arms connecting the ring to the prongs, and wherein the sensor coils surround a corresponding arm.

### DESCRIPTION OF THE PREFERRED EMBODIMENT

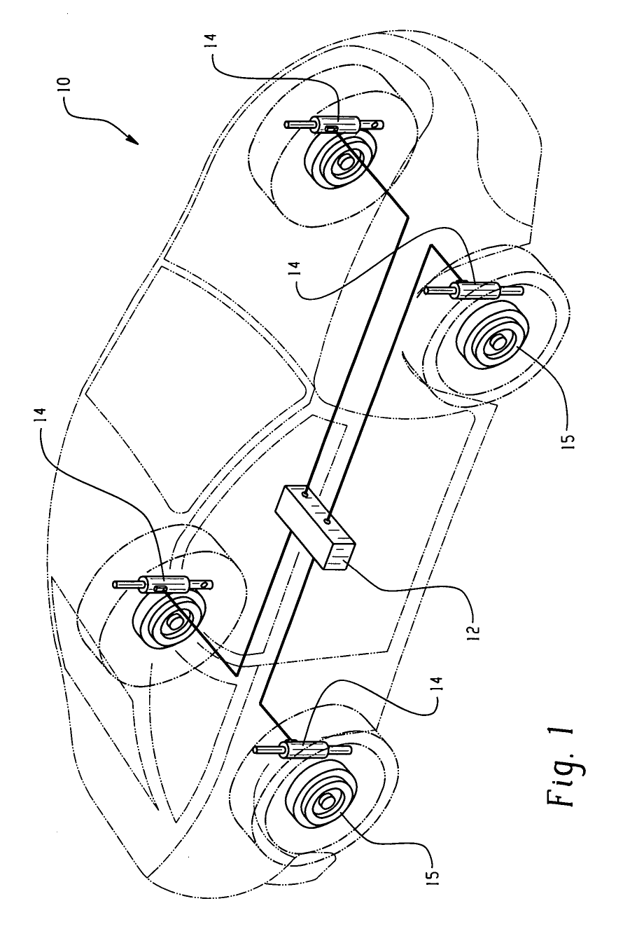

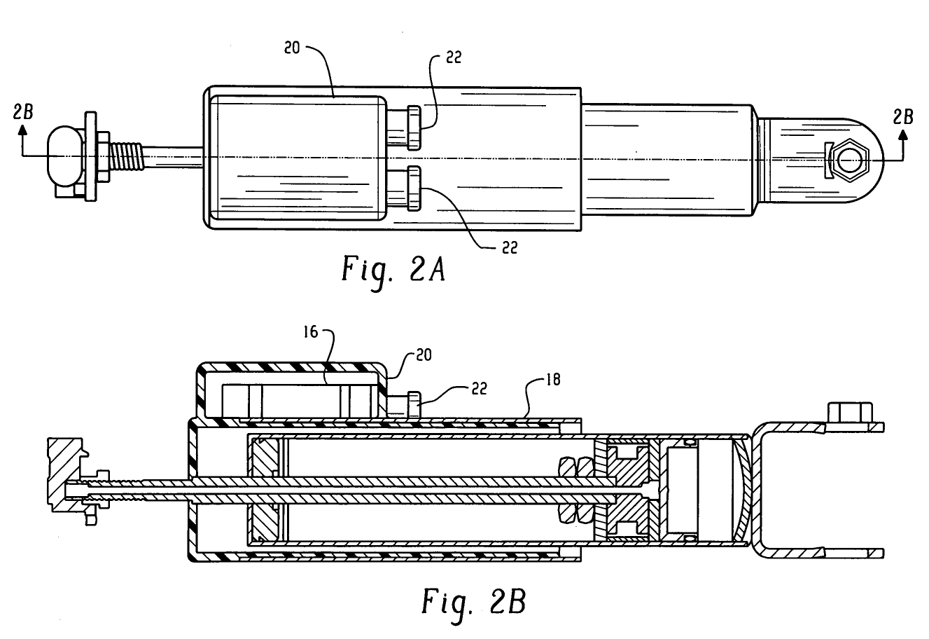

FIG. 1 is a schematic view of an exemplary embodiment of a suspension control system configuration 10. Suspension control system 10 includes an optional central controller 12, and damper assemblies 14, with each damper assembly being operatively connected between the car body or frame and a respective one of the vehicle wheels 15. Each damper assembly may, for example, be a magnetorheological damper. As shown in FIGS. 2A and 2B, each damper assembly 14 includes and integrated local controller 16 and an integrated sensor coil 18. The local controller 16 may be located in a compartment 20 on the housing of the damper assembly and may have multiple interface ports 22 for connecting to receive power from a power source and for connecting to communicate with the central controller 12. The interface ports may be formed by a suitable electrical connector structure, but preferably one that will provide a seal when connected to the corresponding connector of a communication line or power line. Sensor coil 18 is preferably an integrated sensor and, in one embodiment, is a relative velocity sensor. The damper may include other integrated sensors, such as position, vibration or temperature sensors.

In one embodiment, where central controller 12 is not provided, the local controller 16 of each damper assembly effects local suspension control functions (e.g., by controlling the energization level of its damper coil) without reference to the local suspension control functions being carried out by the other damper assemblies.

In another embodiment, where central controller 12 is provided and utilized, suspension control system 10 provides a damper control system having a hierarchical or distributed structure of control. Control functions are divided between the central controller 12 and the integrated local controller or control unit 16 of each damper 14. The central controller 12 may provide high level commands to the integrated local controller 16 of each damper 14. The local controller 16 operates as an intelligent device interpreting the command from the central controller and adjusting its control functions accordingly. By way of example, the local controller of damper 14 may normally operate substantially independently of central controller 12 to effect control functions such as temperature compensation, failsafe, wheel control and linearizational response. Lower-frequency control functions may be handled by operation of the central controller 12, which communicates with each of the local controllers 16. One example of a lower frequency control function would be adjusting an overall suspension stiffness setting, in which case the central controller 12 would communicate the setting adjustment to the local controller 16 of each damper assembly 14 so that the local controller 16 could adjust its future control functions accordingly. In another example, the central controller 12 may monitor various drive conditions of the vehicle, such as heave, roll, pitch and yaw, as determined by inputs from appropriate sensors. When the central controller 12 determines that one or more drive condition criteria are met, the central controller 12 communicates with each local controller 16 to affect suspension control operations, effectively overriding the local suspension control functions carried out by the local controller 16.

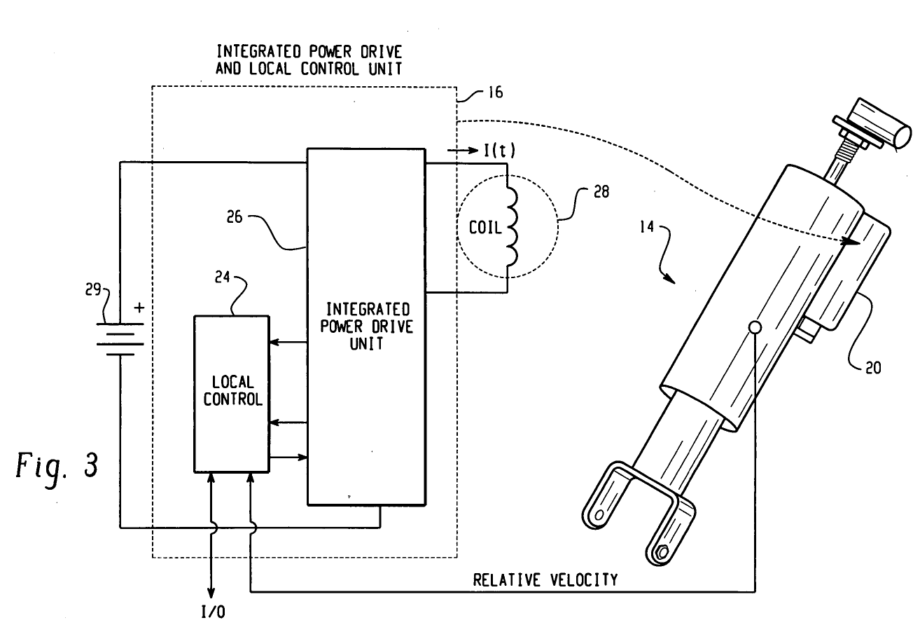

FIG. 3 illustrates one embodiment of a local controller 16 of the damper 14 illustrated in FIGS. 2A and 2B. Local controller 16 of damper 14 includes an integrated power drive unit 26 and a control unit 24. Damper 14 includes an integrated relative velocity sensor such as those described in more detail below. The integrated power drive unit 26 provides variable electrical current to the ungrounded damper coil 28 of the assembly to adjust the damping properties of the damper assembly.

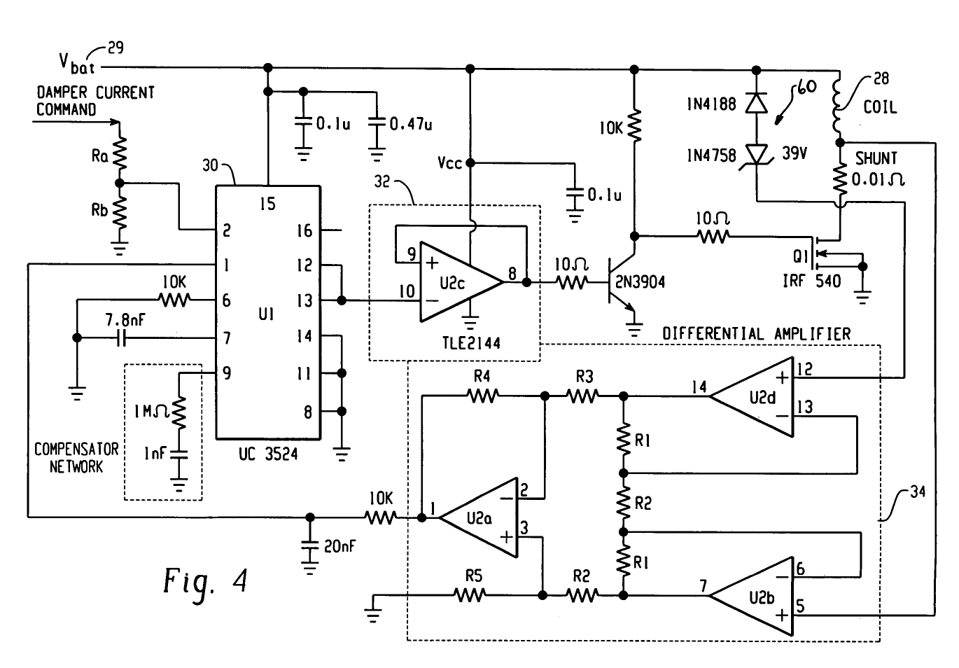

FIG. 4 is a schematic illustration of a more detailed embodiment a power drive unit that might be used in each damper assembly. Damping force is regulated using pulse width modulation (PWM) current control to the ungrounded damper coil 28, with current being derived from a power source such as a vehicle battery 29. The power drive unit utilizes a PWM dedicated control integrated circuit (IC) 30, such as the UC 3524, in combination with an operational amplifier control side circuit arrangement 32, and an operational amplifier feedback side circuit arrangement 34, to effect PWM switching of the transistor 36. A shunt resistor is connected in series with the damper coil 28 and the tap point for one feedback line to circuit arrangement 34 is between the damper coil and shunt resistor. Another feedback line to circuit 34 is provided from the back to back connected Zener diode and Schottkey diode pair 60.

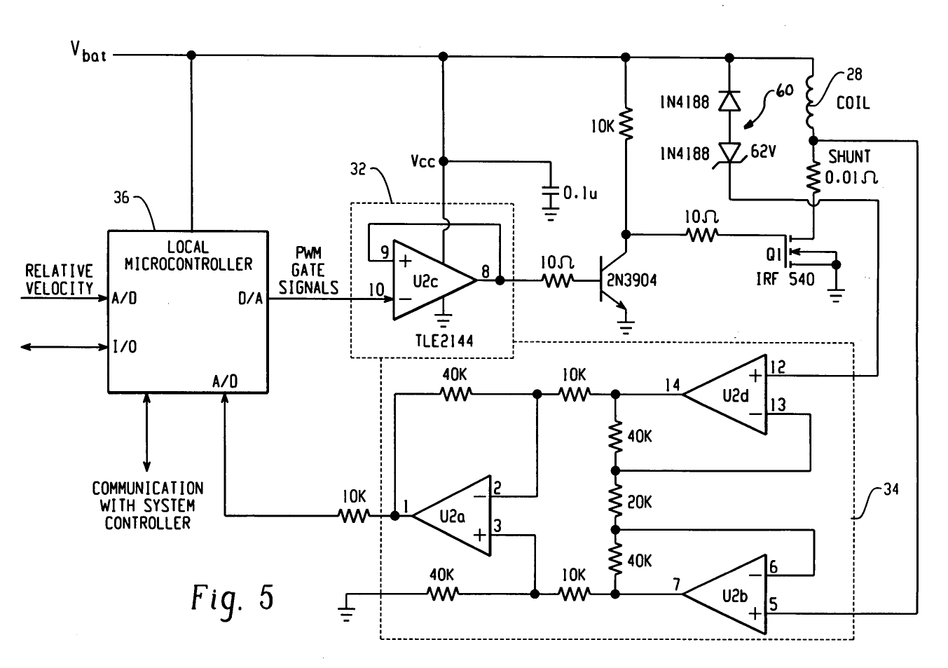

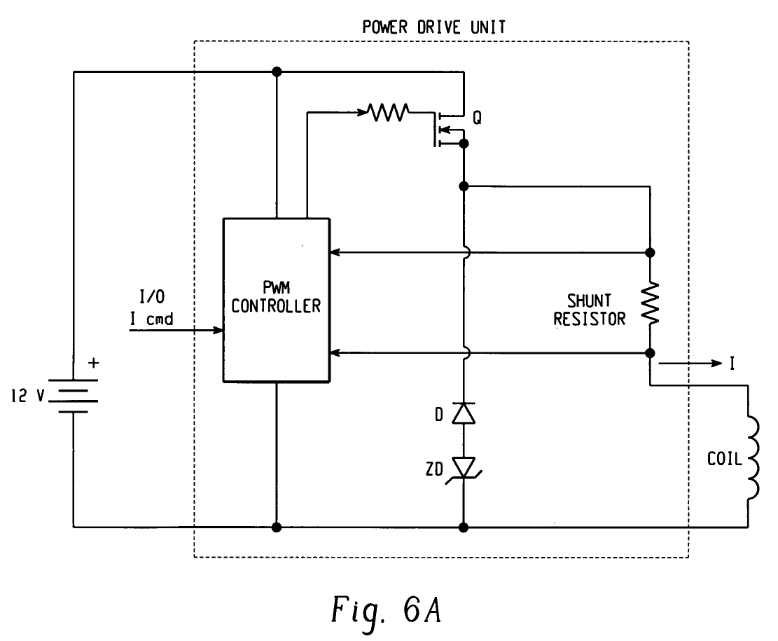

FIG. 5 is schematic illustration of another embodiment of a power drive unit utilizing a local micro controller 36 in place of the dedicated PWM IC 30 of FIG. 4. In this embodiment, the PWM control and processing of sensor output will be handled by the local micro controller 36. Again, a shunt resistor is connected in series with the damper coil 28 and the tap point for one feedback line to circuit arrangement 34 is between the damper coil and shunt resistor, while the other feedback line is provided from the back to back connected Zener diode and Schottkey diode pair 60.

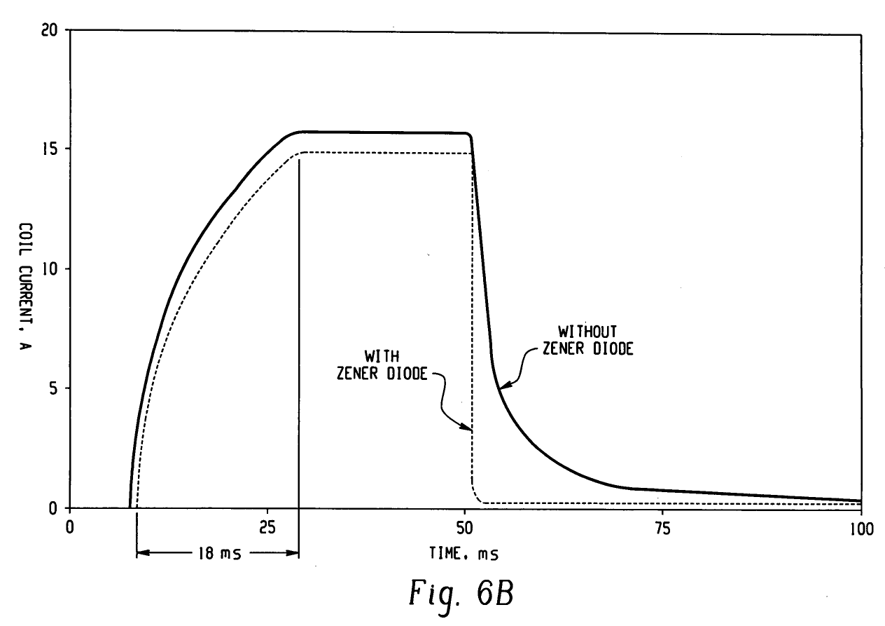

FIGS. 6A and 6B illustrate a prior art power drive unit of a type normally located on a central controller of a suspension control system.

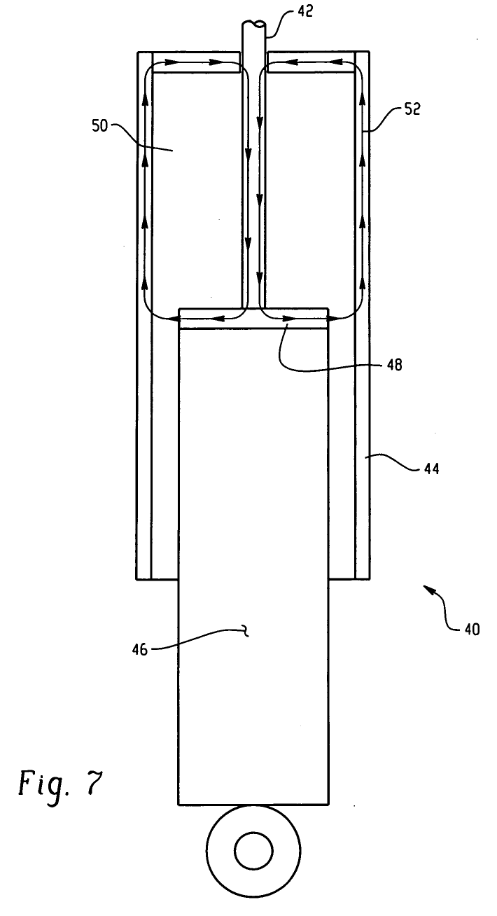

FIG. 7 illustrates a diagrammatic representation of a known damper 40 including an integrated relative velocity sensor. The control of dampers in real-time damping systems requires the instantaneous relative damper velocity as a control variable. Damper 40 uses concentrated magnets 48 mounted on the damper body 46 with a distributed coil 50 mounted coaxially on an external dust tube 44. These sensors are adequate when the stroke of the damper is less than two times its diameter. In dampers with very long strokes of greater than four times the diameter, poor performance may result due to the concentrated magnet. The damper piston rod 42 is used as a flux carrier with the flux 52 exiting the shock body in the radial direction across a cylindrical gap to the distributed coil on the dust tube. As such, this type of sensor is sensitive to the radial flux produced by MR type sensors with internal solenoids. While this damper 40 and integrated velocity sensor construction may in some cases be used in connection with the above-described novel hierarchical suspension control system, an improved damper construction and related integrated velocity sensor as described below may provide additional benefits.

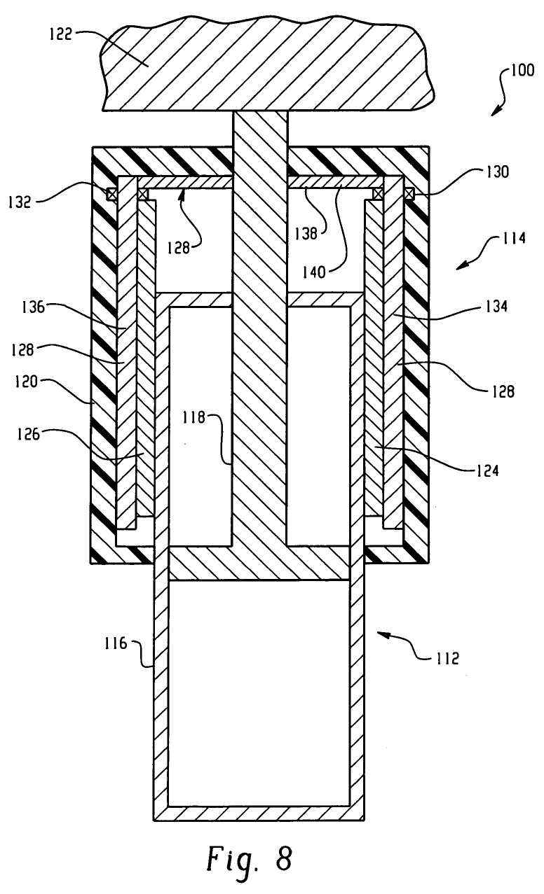

Referring to FIGS. 8, 9 and 10, a damper assembly 100 including a damper 112 and a relative velocity sensor 114 is shown, substantially as described in U.S. patent application Ser. No. 10/643,524, filed Aug. 19, 2003, the specification of which is incorporated herein by reference. The damper 112 includes a damper body (i.e., a damper cylinder) 116, a piston rod 118, and a dust tube 120. The piston rod 118 is axially movable within the damper body 116 and is attachable to a vehicle frame or body 122 (only a portion of which is shown in FIG. 8). The dust tube 120 circumferentially surrounds at least an axial portion of the damper body 116 and is attached to the piston rod 118. The relative velocity sensor 114 includes spaced apart and axially extending first and second magnets 124 and 126 which are supported by the dust tube 120, includes a flux (i.e., magnetic flux) collector 128, and includes spaced apart first and second sensor coils 130 and 132. The flux collector 128 is supported by the dust tube 120, includes an axially-extending first prong 134 in axially-extending contact with the first magnet 124, includes an axially-extending second prong 136 in axially-extending contact with the second magnet 126, and includes a joining member 138 connecting the first and second prongs 134 and 136. The first sensor coil 130 surrounds the joining member 138 and/or the first prong 134, and the second sensor coil 132 surrounds the joining member 138 and/or the second prong 136. The term “attached” includes directly attached or indirectly attached. The term “supported” includes directly supported or indirectly supported.

The relative velocity sensor 114 is used to measure the relative velocity of the damper body 116 relative to the dust tube 120. In one implementation of the first expression of the embodiment of FIG. 8, the voltage induced in the sensor coils from the relative velocity of the damper body 116 relative to the dust tube 120 is substantially proportional to such relative velocity, as can be appreciated by those skilled in the art. In the same or a different implementation, the damper 112 is a magnetorheological damper.

In one choice of materials for the first expression of the embodiment of FIG. 8, the dust tube 120 is not magnetizable such as being a plastic dust tube. In the same or a different choice of materials, the flux collector 128 is magnetizable and consists essentially of a ferromagnetic material such as steel. In the same or a different choice of materials, in an example where the magnets 124 and 126 are permanent magnets, the first and second magnets 124 and 126 consist essentially of Alnico 8 or bonded NdFeB or other suitable permanent magnet material. In the same or a different choice of materials, the piston rod 118 consists essentially of a low-magnetic stainless steel or a nonmagnetic stainless steel, and the damper body 116 consists essentially of steel. In one arrangement, the first and second sensor coils 130 and 132 are connected in series.

In one example of the first expression of the embodiment of FIG. 8, the first and second prongs 134 and 136 are attached to the inside of the dust tube 120. In the same or a different example, the first magnet 124 is attached to the first prong 134, and the second magnet 126 is attached to the second prong 136. In the same or a different example, the joining member 138 includes a ring 140 coaxially aligned with the dust tube 120. In one design, the first and second magnets 124 and 126 do not axially extend to the ring 140 but are axially spaced apart from the ring 140. In one illustration, the first and second magnets 124 and 126 axially extend a distance which is greater than the inside diameter of the damper body 16, and in one variation axially extend a distance at least equal to substantially the stroke of the piston rod 118. In the same or a different illustration, the first and second prongs 134 and 136 axially extend a distance which is greater than the inside diameter of the damper body 116, and in one variation axially extend a distance at least equal to substantially the stroke of the piston rod 118.

In one variation of the first expression of the embodiment of FIG. 8, the first and second prongs 134 and 136 and the first and second magnets 124 and 126 are substantially aligned along a diameter of the dust tube 120. In this variation, the first prong 134 and the first magnet 124 are one-hundred eighty degrees apart from the second prong 136 and the second magnet 126. In one modification, the first sensor coil 130 surrounds the first prong 134, and the second sensor coil 132 surrounds the second prong 136. In an application where the piston rod 118 is attached to a vehicle frame or body 122 and is substantially vertically oriented, the first and second sensor coils 130 and 132 are said to be vertically mounted. It is noted that all of the magnetic flux will flow through both the first and second sensor coils 130 and 132 improving the signal level of the relative velocity sensor 114, as is understood by the artisan.

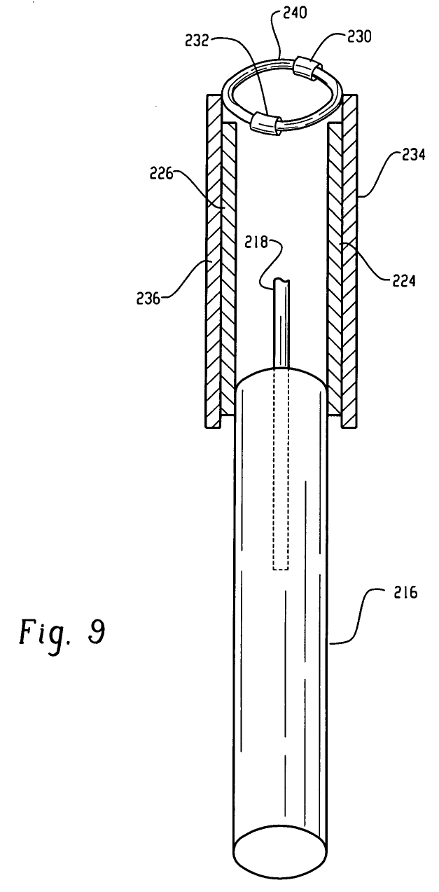

An alternate placement of the first and second sensor coils 230 and 232 is shown in FIG. 9. In FIG. 9, the first sensor coil 230 surrounds a first circumferential segment of the ring 240, the second sensor coil 232 surrounds a second circumferential segment of the ring 240, and a line between the first and second sensor coils 230 and 232 is substantially perpendicular to the diameter aligned with the first and second magnets 224 and 226 and prongs 234 and 236. FIG. 9 also shows the piston rod 218 and the damper body 216, but the dust tube has been omitted for clarity. In an application where the piston rod is attached to a vehicle frame and is substantially vertically oriented, the first and second sensor coils 230 and 232 are said to be horizontally mounted. It is noted that one-half of the magnetic flux will flow through the first sensor coil 230 and the other-half of the magnetic flux will flow through the second sensor coil 232, as is understood by the artisan.

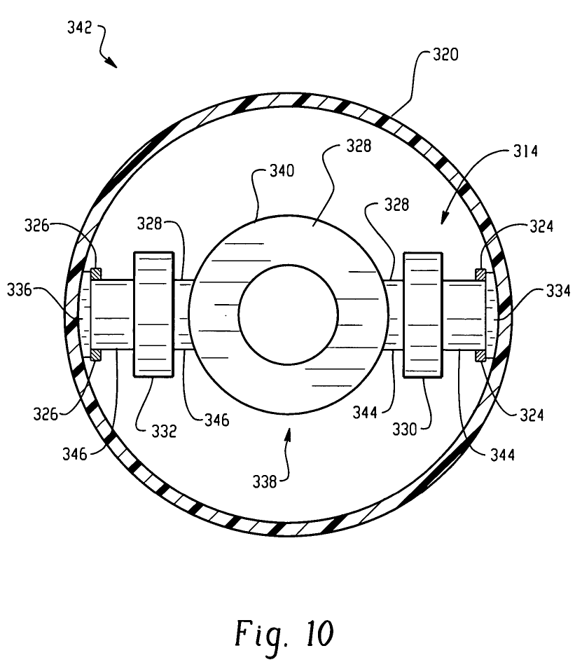

An alternate embodiment of a dust tube subassembly 342 (i.e., a subassembly including at least a dust tube 320 and at least some components of a relative velocity sensor 314) is shown in FIG. 10. In FIG. 10, the ring 340 of the flux collector 328 is smaller than that of FIGS. 8 and 9. In the embodiment of FIG. 3, the joining member 338 includes a first arm 344 connecting the ring 340 to the first prong 334 and includes a second arm 346 connecting the ring 340 to the second prong 336. The first sensor coil 330 surrounds the first arm 344, and the second sensor coil 332 surrounds the second arm 346. In an application where the piston rod is attached to a vehicle frame and is substantially vertically oriented, the first and second sensor coils 330 and 332 are said to be horizontally mounted. It is noted that all of the magnetic flux will flow through both the first and second sensor coils 330 and 332 improving the signal level of the relative velocity sensor 314, as is understood by the artisan. FIG. 10 also shows top-end portions of the first and second magnets 324 and 326.

The damper constructions of FIGS. 8, 9 and 10 would incorporate an integrated local controller, as previously described, in connection with their use in a suspension control system as previously described.

The foregoing description has been presented for purposes of illustration. It is not intended to be exhaustive or to limit the invention to the precise forms or procedures disclosed, and obviously many modifications and variations are possible in light of the above teaching. For example, various types of damper assemblies are known and could be used, including dampers that utilize flow control valves, motors or even electrodes in the case of Electro-Rheological (ER) dampers. As used herein the terminology “damping control component” is intended to encompass damper coils as primarily described above, as well as any other such control component used in other types of dampers. It is intended that the scope of the invention be defined by the claims appended hereto.

1. A hierarchical suspension control system in a wheeled vehicle, comprising:
a plurality of damper assemblies, each damper assembly operatively connected between a vehicle body and a corresponding vehicle wheel, each damper assembly including an integrated sensor and an integrated local controller with a drive unit connected to a damping control component of the damper assembly;
a central controller connected for communication with the integrated local controller of each damper assembly;
wherein, at least during certain times, the local controller of each damper assembly controls the damper assembly independently of the central controller for carrying out at least one local suspension control function of the damper assembly;
wherein, at least during certain other times, the central controller communicates with the local controller of each damper assembly for overriding the at least one local suspension control function.

2. The hierarchical suspension control system of claim 1 wherein the at least one local suspension control function comprises one or more of a temperature compensation function, a failsafe function, a wheel control function and a linearizational response function.

3. The hierarchical suspension control system of claim 11 wherein the central controller operates to override the at least one local suspension control functions when the central controller determines that one or more criteria are met.

4. The hierarchical suspension control system of claim 3 wherein the central controller receives input from at least one sensor and the one or more criteria are related to the input received from the at least one sensor.

5. The hierarchical suspension control system of claim 1 wherein the damper control component comprises a damper coil.

6. The hierarchical suspension control system of claim 5 wherein the power drive unit includes a shunt resistor connected in series with the damper coil and a feedback line connected between the shunt resistor and damper coil.

7. A hierarchical suspension control system, comprising:
a plurality of damper assemblies, each damper assembly including an integrated velocity sensor and an integrated local controller with a drive unit connected to a damping control component of the damper assembly;
a central controller connected for communication with the integrated local controller of each damper assembly;
at least one sensor providing ride condition input to the central controller;
wherein, the local controller of each damper assembly normally controls the damper assembly independently of the central controller for carrying out at least one local suspension control function of the damper assembly;
wherein the central controller monitors the at least one sensor to identify when one or more drive condition criteria are met and, when the one or more drive condition criteria are met, communicates with the local controller of one or more of the damper assemblies so as to affect suspension control functions of the one or more damper assemblies.

8. A suspension control system in a wheeled vehicle, comprising:
a plurality of damper assemblies, each damper assembly operatively connected between a vehicle body and a corresponding vehicle wheel, each damper assembly including an integrated sensor and an integrated local controller with a drive unit connected to a damping control component of the damper assembly;
wherein the local controller of each damper assembly independently controls its damper assembly without reference to control operations being carried out by the local controllers of other damper assemblies.

9. A self-contained piston damper unit, comprising:
a damper body;
a piston rod that is axially movable within the damper body and that is attachable to a vehicle body;
a relative velocity sensor providing an output indicative of relative velocity as between the piston rod and damper body;
a local controller connected to receive an output of the relative velocity sensor and including a drive unit connected for energizing a damper coil of the damper unit, the local controller configured for independently controlling energization of the damper coil throughout a range of energization levels and at least partly in response to the output of the relative velocity sensor;
wherein the damper body, piston rod, relative velocity sensor and local controller with damper coil drive unit are integrated into a single assembly mountable as a unit to a vehicle.

10. The self-contained piston damper unit of claim 8 wherein the unit includes a housing compartment containing the local controller.

11. The self-contained piston damper unit of claim 10 wherein the local controller includes an interface enabling connection to an external controller.

12. The self-contained piston damper unit of claim 11 wherein the housing compartment includes at least one port associated with the interface of the local controller for connecting to a communication line.

13. The self-contained piston damper unit of claim 12 wherein the housing compartment includes at least one other port for connecting to a power line.

14. In a suspension control system of a wheeled vehicle including multiple damper assemblies, each damper assembly associated with a respective wheel of the vehicle, a method for effecting suspension control functions by the damper assemblies, the method comprising the steps of:
providing each damper assembly with an integrated local controller and associated damping component drive unit;
connecting the damping component drive unit of each damper assembly to a power source;
configuring the local controller of each damper assembly to independently effect one or more local suspension control functions without reference to local suspension control functions being carried out by the other damper assemblies.

15. The method of claim 14, further comprising the steps of:
connecting the integrated local controller of each damper assembly for communication with a central controller;
configuring the central controller to carry out at least one override suspension control function via communication with the local controller of each damper assembly.
